(19) United States
(12) Patent Application Publication
(10) Pub. No.: US 2024/0227477 A9
(43) Pub. Date: Jul. 11, 2024

(54) TRAILER TOW CONNECTOR WITH LIGHT AND MAGNETIC GUIDE

(71) Applicant: STONERIDGE CONTROL DEVICES, INC., NOVI, MI (US)

(72) Inventors: Marco Antonio Avalos Ponce, Juarez (MX); Cesar Gerardo Ramos Martinez, Juarez (MX)

(21) Appl. No.: 18/380,461

(22) Filed: Oct. 16, 2023

Related U.S. Application Data
(60) Provisional application No. 63/417,872, filed on Oct. 20, 2022.

(51) Int. Cl. B60D 1/64; B60Q 11/00

(52) U.S. Cl. CPC B60D 1/64; B60Q 11/005

(57) ABSTRACT

A trailer tow connector for a vehicle used in towing a trailer includes a housing that includes a body that has a cavity with electrical terminals that are configured to be in communication with a vehicle's electrical system. A cover is supported on the body and movable between a closed position in which the cavity is enclosed by the cover and an open position in which the cavity is accessible. A light is arranged in the housing and configured to illuminate the electrical terminals with the cover in the open position.

### CROSS-REFERENCE TO RELATED APPLICATION

This application claims priority to U.S. Provisional Application No. 63/417,872 filed Oct. 20, 2022.

### BACKGROUND

This disclosure relates to a trailer tow connector having a light, diagnostics, and enhanced guidance between the trailer tow connector and a trailer connector.

Various systems from a trailer must be connected to a tow vehicle, such as a passenger truck. Typically a 4-way or 7-way trailer tow connector with wire terminals is removably connected to a corresponding trailer connector with wire terminals such that the trailer's parking brake lights, turn signals, and brake lights can be operated in unison with the vehicle's lights. In the case of a 7-way connector, the vehicle may also operate electric trailer brakes through the trailer tow connector and trailer connect junction.

The tractor/trailer electrical connection is made by hand, often in poor weather conditions or in the dark, when connecting the trailer hitch to the vehicle. After making this connection, it is not uncommon for there to be a poor electrical connection between the trailer tow connector and the trailer connector, which can be difficult to troubleshoot.

There are many integrated diagnostic devices in the marketplace for identifying poor electrical connection at the tractor/trailer electrical connection. However, these diagnostics are provided on the trailer connector only, and not on the trailer tow connector on vehicle. Moreover, while there are locating and interlocking features between the trailer tow connector and the trailer connector, it is still difficult to locate the connectors relative to one another during hook up.

### SUMMARY

In one exemplary embodiment, a trailer tow connector for a vehicle used in towing a trailer includes a housing that includes a body that has a cavity with electrical terminals that are configured to be in communication with a vehicle's electrical system. A cover is supported on the body and movable between a closed position in which the cavity is enclosed by the cover and an open position in which the cavity is accessible. A light is arranged in the housing and configured to illuminate the electrical terminals with the cover in the open position.

In a further embodiment of any of the above, the light is configured to illuminate the electrical terminals only with the cover in the open position.

In a further embodiment of any of the above, the trailer tow connector includes a switch that is provided in an electrical circuit with the light. The switch is actuated in response to the cover that moves between the open position and the closed position.

In a further embodiment of any of the above, the light is provided on the body.

In a further embodiment of any of the above, the light is provided within the cavity.

In a further embodiment of any of the above, the light is an LED.

In a further embodiment of any of the above, the LED is configured to change state in response to a diagnostic test.

In a further embodiment of any of the above, the light includes first and second states. The first state corresponds to a first color that illuminates the electrical terminals, and the second state corresponds to a second color that indicates a test result relating to a connection between a trailer connector and the electrical connector. The first color provides greater illumination than the second color.

In a further embodiment of any of the above, the trailer tow connector includes a controller that is configured to run a test between the electrical terminals and a trailer connector.

In a further embodiment of any of the above, the controller is provided in the housing.

In a further embodiment of any of the above, the test performs one of a voltage, current, or resistance test on the electrical terminals of the trailer tow connector when connected to the trailer connector.

In a further embodiment of any of the above, the trailer tow connector includes a magnetic guide that is configured to magnetically couple to a feature on the trailer connector.

In a further embodiment of any of the above, the magnetic guide is provided on an interlocking feature of the trailer connector that is configured to cooperate with a complimentary feature of a trailer connector.

In a further embodiment of any of the above, the feature is a notch.

In a further embodiment of any of the above, the feature is a ground terminal of the electrical terminals.

In a further embodiment of any of the above, the electrical terminals are provided by seven terminals or four terminals.

In another exemplary embodiment, a method of illuminating a trailer tow connector includes opening a cover with respect to a body, and illuminating electrical terminals within the body.

In a further embodiment of any of the above, the illuminating step is performed when opening a cover that is pivotally attached to the body.

In a further embodiment of any of the above, the method includes changing a state of illumination based upon a test result when connecting a trailer connector to the electrical terminals.

In a further embodiment of any of the above, the method includes changing colors of an LED.

### BRIEF DESCRIPTION OF THE DRAWINGS

The disclosure can be further understood by reference to the following detailed description when considered in connection with the accompanying drawings wherein:

FIG. 1 is a schematic view of a tow vehicle and a trailer with connectors that cooperate with one another to provide an electrical connection between the vehicle and trailer.

FIGS. 2A-2C respectively illustrate a perspective view of a combination 7-way/4-way trailer tow connector, a top view of the trailer tow connector and an enlarged perspective view of the 4-way connector terminals.

FIG. 3 is a schematic view of the 4-way connector with a light and diagnostic system.

FIG. 4 is a schematic view of the 7-way connector and the trailer connector having enhanced guidance features.

FIG. 5 is a flowchart illustrating operation of the disclosed trailer tow connector.

FIG. 6 is a flowchart depicting operation of the enhanced guidance system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

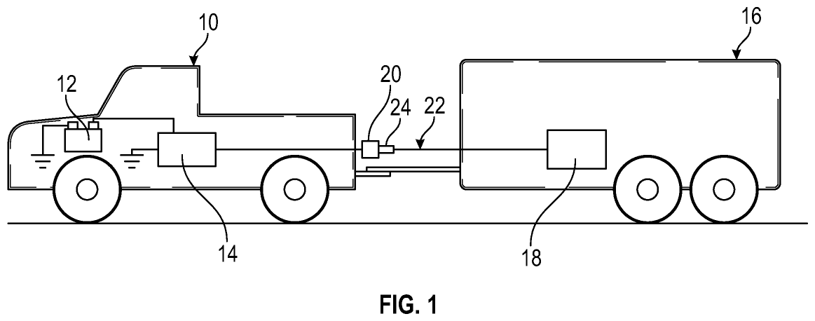

A tow vehicle 10 towing a trailer 16 is illustrated in FIG. 1. The vehicle 10 includes a power source 12 that supplies electrical power to a vehicle electrical system 14, which includes, for example, parking lights, brake lights, turn signals, and backup lights.

A trailer 16 includes a trailer electrical system 18 that includes, for example, parking lights, brake lights, turn signals, backup lights, and an electric brake system. The vehicle and the trailer electrical systems 14, 18 are electrically connected to one another by a trailer tow connector 20 on the tow vehicle 10 that interconnects to a trailer connector 24 on a wiring harness or pigtail 22 that is electrically connected to the trailer electrical system 18.

The electrical connection between the trailer tow connector 20 and the trailer connector 24 must be robust and reliable to ensure power to the trailer electrical system 18 during operation. This may be difficult due to corrosion in the connector's terminals and poor visibility due to inclement weather or lighting conditions. To this end, the disclosed systems provide improved visibility, economical diagnostics, and enhanced guidance between the connectors during hookup.

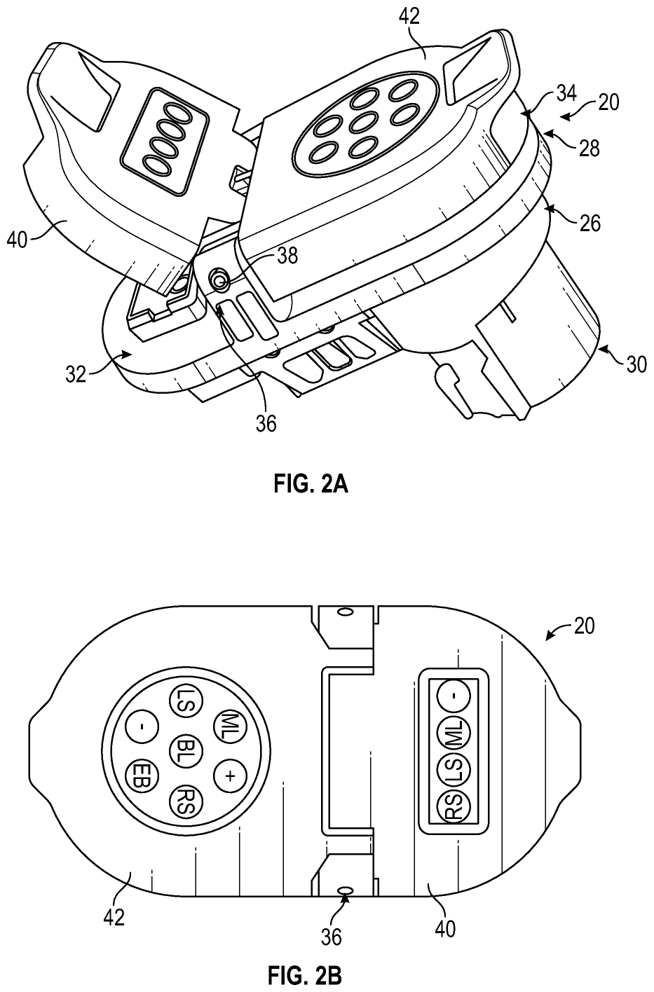

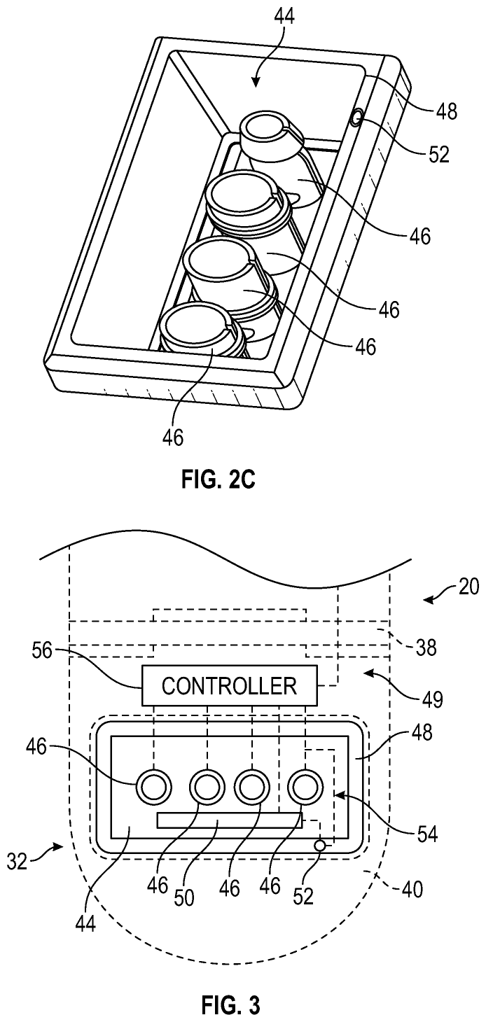

An example standard trailer tow connector 20 provides a combination 4-“way”/7-“way” (or “pole” or “terminal”) connector, which is illustrated in FIGS. 2A-2C. The example trailer tow connector 20 includes a plastic housing 26 providing first and second ends 28, 30 opposing one another. The first end 28 is arranged facing the exterior of the tow vehicle 10, typically near the vehicle's rear bumper. The second end 30 is connected to the vehicle electrical system 14 by a wiring harness, as is known. The housing 26 includes first and second bodies 32, 34 at the first end 28, which respectively provide the 4-way connector and the 7-way connector.

First and second covers 40, 42 are respectively arranged over the first and second bodies 32, 34 and are pivotal about a hinge 36 having a common pin 38 in the example. One or more springs bias the first and second covers 40, 42 to a closed position over the terminals 46 to provide a weather-type seal. It should be understood that this disclosure covers other types or configurations of trailer tow connectors than those described herein. FIG. 2B depicts both covers in a closed position, and FIG. 2A illustrates the 4-way cover in an open position.

As shown in FIG. 2C, terminals 46 are arranged within a cavity 44 (one shown) in each of the first and second bodies 32, 34, and which receives a corresponding end the trailer connector 24. A wall 48, which circumscribes each of the cavities 44, may extend from the housing 26 toward its respective cover and seal against a rubber seal on an underside of the respective cover when in the closed position.

There is only one way in which to properly mate the trailer tow and trailer connectors 20, 24 to ensure the corresponding terminals are connected to one another. To this end, the connectors include complementary locating features to ensure that the connectors are clocked or aligned with one another as desired. Nonetheless, this process can be difficult in, for example, the dark, the snow and/or rain. While lighting at or near the connector may be helpful, it is desirable to provide illumination in the cavity 44 as the terminals are recessed within and not easily visible. To address this issue, one or more lights 50 (“light 50”; e.g., color changeable LED) are provided within the cavity 44 to illuminate the terminals 46. A single light may circumscribe the entire cavity, a discrete light may be provided for each wire terminal (which may be useful for diagnostics), or other light configurations may be provided as desired.

Referring to FIG. 3, the light 50 may switch ON and OFF with the vehicle's headlights or daytime running lights. Alternatively or additionally, the light 50 can be turned ON/OFF by a switch 52, which may be a momentary switch actuated to turn the light 50 ON when the cover 40 is open to enable the user to more easily insert the trailer tow connector 20 into the cavity 44. While the light 50 is shown only on the 4-way side of the trailer tow connector, a light 50 may be provided in each cavity (i.e., in each cavity 44 of both the first and second bodies 32, 34).

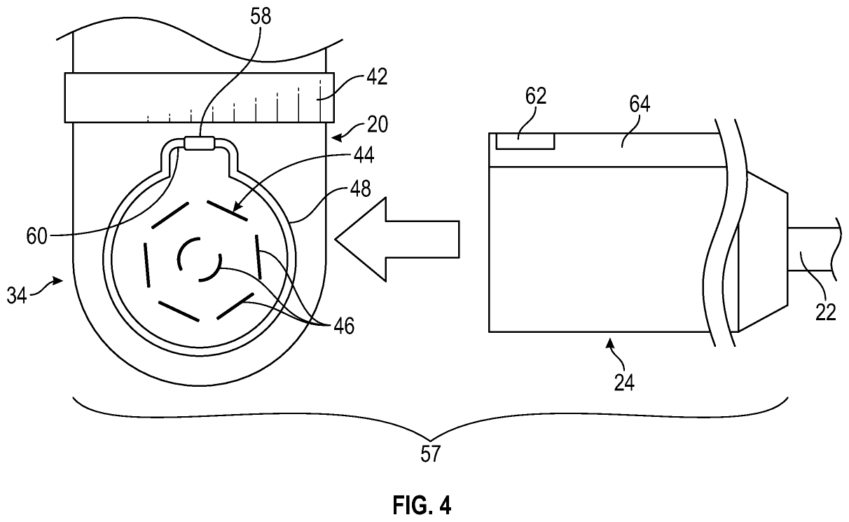

A guidance system 57 is provided between the trailer tow and trailer connectors 20, 24 that better facilitates connection in low- or no-light conditions or blind connections. Referring to FIG. 4, the trailer tow connector 20 includes a first magnetic element 58, which is positioned with respect to a first locating feature 60. The trailer connector 24 includes a second magnetic element 62 which is similarly positioned with respect to a second locating feature, such that when the trailer tow connector 20 and the trailer connector 24 are connected as desired with one another, the first and second magnetic elements 58, 62 are in alignment with one another.

In one example, at least one the first and second magnetic elements 58, 62 are provided by strong permanent magnets, such as neodymium. In another example, one or both of the first and second magnetic elements 58, 62 may be a temporary magnet in which the magnetic field is generated during connector coupling. For example, when a cover is opened (e.g., detected by switch 52), the first magnetic element 58 is energized to attract the second magnetic element 62, which could be provided by a ferrous member or a permanent magnet of an opposite polarity.

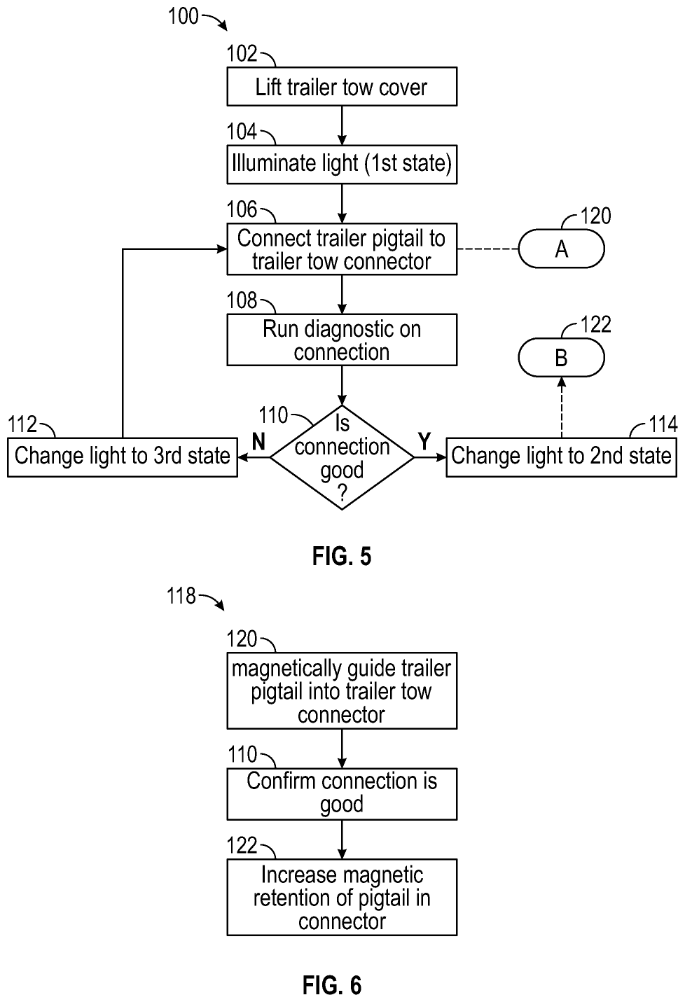

Returning to FIG. 3, the light 50 may also or alternatively be operated in response to a command from a controller 56. The controller 56, which may be part of a diagnostic system 49, is arranged within the housing 26, for example. The controller 56 may instead be provided elsewhere on the vehicle 10, for example, as part of a body module. The diagnostic system 49 via the controller 56 evaluates when the trailer tow connector 20 is connected to the trailer connector 24 as desired according to a diagnostic method illustrated in FIG. 5.

FIG. 5 illustrates a method 100 of illuminating a trailer tow connector 20 during use. The illumination may be provided only for visibility or may be provided as part of a diagnostic procedure. In one example method, one of the covers on the trailer tow connector 20 is lifted (block 102), which exposes the wire terminals 46. The switch 52 actuates the light 50 in response to the cover opening, providing a first state of illumination (block 104) that may be provided by a white light for maximum illumination.

The trailer connector 24 is inserted into the illuminated cavity 44 of the trailer tow connector 20 (block 106). If the disclosed diagnostic system 49 is used, the controller 56 will run a diagnostic on the quality of the connection between the wire terminals of the trailer tow and trailer connectors 20, 24 (block 108). The diagnostic system 57 will perform an analysis (e.g., by monitoring resistance, current, voltage) for each wire terminal connection to determine if the connection is good (block 110). If all the connections are good, then the light 50 is changed to a second state of illumination (block 114), for example, by changing color to green, flashing, or other visual change. If any of the connections are bad (i.e., would result in improper operation of the trailer electrical system 18), then the light 50 is changed to a third state of illumination (block 112), for example, by changing color to red, flashing, or other visual change distinct from the first and second states of illumination.

A method of guidance 118 may be provided when connecting the trailer tow and trailer connectors 20, 24, as shown in FIGS. 5 and 6. While connecting the trailer connector 24 to the trailer tow connector 20 (block 106 in FIG. 5), the trailer connector 24 may be magnetically guided into the cavity 44 of the trailer tow connector 24 (block 120). In instances where an electrically actuated magnet and diagnostic system 57 are used, the magnetic field is increased (block 122) upon confirming all the electrical connections are good (block 110).

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A trailer tow connector for a vehicle used in towing a trailer, comprising:
a housing including a body having a cavity with electrical terminals configured to be in communication with a vehicle's electrical system, a cover supported on the body and movable between a closed position in which the cavity is enclosed by the cover and an open position in which the cavity is accessible; and
a light arranged in the housing and configured to illuminate the electrical terminals with the cover in the open position.

2. The trailer tow connector of claim 1, wherein the light is configured to illuminate the electrical terminals only with the cover in the open position.

3. The trailer tow connector of claim 2, comprising a switch provided in an electrical circuit with the light, the switch actuated in response to the cover moving between the open position and the closed position.

4. The trailer tow connector of claim 3, wherein the light is provided on the body.

5. The trailer tow connector of claim 4, wherein the light is provided within the cavity.

6. The trailer tow connector of claim 5, wherein the light is an LED.

7. The trailer tow connector of claim 6, wherein the LED is configured to change state in response to a diagnostic test.

8. The trailer tow connector of claim 7, wherein the light includes first and second states, the first state corresponds to a first color illuminating the electrical terminals, and the second state corresponds to a second color indicating a test result relating to a connection between a trailer connector and the electrical connector, the first color providing greater illumination than the second color.

9. The trailer tow connector of claim 7, comprising a controller configured to run a test between the electrical terminals and a trailer connector.

10. The trailer tow connector of claim 9, wherein the controller is provided in the housing.

11. The trailer tow connector of claim 9, wherein the test performs one of a voltage, current, or resistance test on the electrical terminals of the trailer tow connector when connected to the trailer connector.

12. The trailer tow connector of claim 1, comprising a magnetic guide configured to magnetically couple to a feature on the trailer connector.

13. The trailer tow connector of claim 12, wherein the magnetic guide is provided on an interlocking feature of the trailer connector configured to cooperate with a complimentary feature of a trailer connector.

14. The trailer tow connector of claim 13, wherein the feature is a notch.

15. The trailer tow connector of claim 13, wherein the feature is a ground terminal of the electrical terminals.

16. The trailer tow connector of claim 1, wherein the electrical terminals are provided by seven terminals or four terminals.

17. A method of illuminating a trailer tow connector comprising:
opening a cover with respect to a body; and
illuminating electrical terminals within the body.

18. The method of claim 17, wherein the illuminating step is performed when opening a cover pivotally attached to the body.

19. The method of claim 17, comprising changing a state of illumination based upon a test result when connecting a trailer connector to the electrical terminals.

20. The method of claim 19, comprising changing colors of an LED.
